(19) United States
(12) Patent Application Publication
(10) Pub. No.: US 2006/0080686 A1
(43) Pub. Date: Apr. 13, 2006

(54) Disk drive unit having a loading mechanism

(75) Inventors: Coen Theodorus Hubertus Fransiscus Liedenbaum, Eindhoven (NL); Waltherus Cornelis Jozef Bierhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/532,925

(22) PCT Filed: Sep. 26, 2003
(86) PCT No.: PCT/IB03/04288

§ 371 Date: Apr. 27, 2005

(30) Foreign Application Priority Data
Oct. 29, 2002 (EP) 02079525.8

(51) Int. Cl. G11B 17/04; G11B 17/03; G11B 33/02

(52) U.S. Cl. 720/601

(57) ABSTRACT

A disk drive unit having a disk loading mechanism, comprising a housing (1) having an opening (5) in a wall thereof for inserting or removing a disk. A disk drive (9) is accommodated in the housing. A loading mechanism for receiving a disk through the opening in the housing and bringing it into engagement with the disk drive comprises a slide (6). This is slidable with respect to the housing and the disk drive between a first position for receiving a disk and a second position covering the opening and allowing the disk drive to engage the disk. The slide is slidable substantially alongside the wall of the housing in which the opening is made and is adapted to receive the disk through the opening in the housing. This leads to a robust and compact structure of the disk drive unit

The present invention relates to a disk drive unit having a disk loading mechanism, and in particular to a disk drive unit comprising:

a housing having an opening in a wall thereof for inserting or removing a disk into or from the housing,

a disk drive accommodated in the housing and adapted to engage and rotate a disk in order to allow a head to read data from or write data on a disk,

a loading mechanism for receiving a disk through the opening in the housing and bringing it into engagement with the disk drive, and vice versa, said loading mechanism comprising:

a slide which is slidable with respect to the housing and the disk drive between a first position for receiving a disk and a second position covering the opening and allowing the disk drive to engage the disk.

Disk drive units having a disk loading mechanism are widely used, particularly in audio, video, and computer devices. Most of these devices are stationary devices. The disk loading mechanisms of these stationary devices include a slide in the form of a drawer having a first position projecting from the housing so as to enable a disk to be placed on the drawer, and a second position in which the drawer has been retracted to close the opening and to allow the disk drive to rotate the disk. An example of such a disk loading mechanism is disclosed in DE-A-34 43 070.

As the disk loading mechanisms as described are relatively fragile, these mechanisms are not very well suited for mobile applications, particularly in miniature devices. A drawer of such a small device would be even more delicate, while there is also more risk of damage due to the transport and handling of such mobile devices, such as telephones and the like.

It is an object of the present invention to provide a new disk drive unit having a disk loading mechanism.

To obtain this object, the invention provides a disk drive unit in which the loading mechanism comprises a slide which is slidable substantially alongside the wall of the housing in which the opening is made and which is adapted to receive the disk through the opening in the housing.

Due to the features of the invention, the slide will not project perpendicularly away from the housing in its fist, opening position, thereby reducing the risk of damage to the slide. This makes the disk drive unit more suitable for use in mobile and/or handheld devices.

It is favourable if the slide comprises a tray to receive the disk in it, said tray having a bottom and circumferential walls sealing against the adjacent wall of the housing.

This sealing of the tray of the slide will limit the penetration of dust or other pollutants into the housing, which could affect the operation of the read/write head of the disk drive, in particular if it concerns so-called a small form factor optical (SFFO) disk drive.

In one embodiment, the slide and the disk drive are operatively coupled to obtain a relative movement during the sliding movement of the slide so as to bring a shaft of the disk drive into and out of engagement with the disk. In a simple embodiment, the slide and the disk drive are mechanically coupled through an operating mechanism. In one embodiment thereof, the operating mechanism comprises at least a groove on one of said slide and disk drive, which groove is slightly offset with respect to a direction substantially parallel to the sliding direction of the slide, and furthermore an engagement member on the other one of said slide and disk drive and adapted to come into engagement with the groove to effect said relative movement.

In this way a very simple mechanical operation of the disk drive is obtained. This mechanical engagement relates to a translational or pivotal movement of the disk drive.

In a simple embodiment, it is further possible that the slide is manually slidable, wherein the slide is, for example, guided on guides on the outside of the housing, the guides being preferably arranged on walls of the housing adjacent the wall having the opening and extending parallel to the direction of movement of the slide. In this way the slide is easy to operate by hand, and this structure may also lead to a small building height of the loading mechanism.

In a particular embodiment, the slide comprises a cover dimensioned so as to cover the opening in the housing wall when the slide is in the second position, which cover slides along the wall of the housing containing the opening, preferably on the outside thereof. The cover and tray may then be positioned substantially adjacent to each other. In this embodiment, it is advantageous if the cover is provided with operating means of the disk drive unit, such as a display, keys and the like, wherein there is an electrical connection between the cover and the housing. As a result, no area of the housing wall is lost for placement of operating means due to the cover or the opening. A further reduction of space loss is obtained if the cover is adapted to slide over operating means of the disk drive unit, such as a display, keys or the like, when in its second position.

Further details and advantages of the invention will be explained in the following description of the Figures in the drawing, schematically showing an embodiment of the invention by way of example.

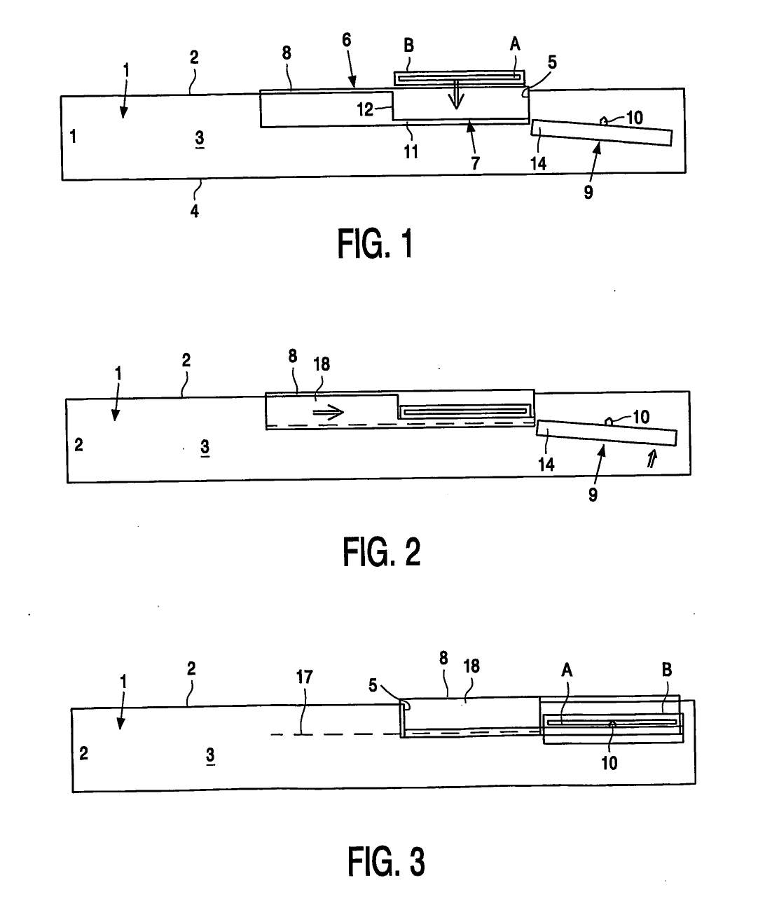

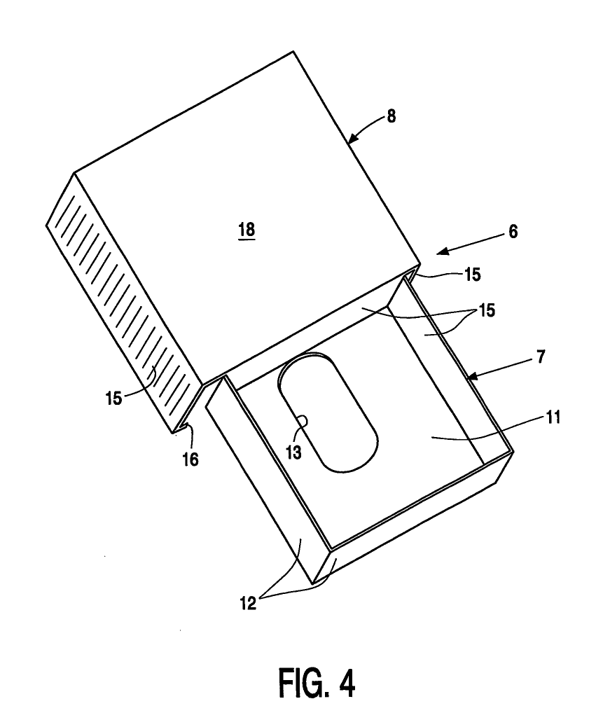

FIGS. 1, 2, 3 are very schematic longitudinal sectional views of a device comprising an embodiment of the disk drive unit according to the invention, in three different positions.

FIG. 4 is a perspective view from above showing the slide from the device of FIGS. 1-3.

The drawings, and particular FIGS. 1-3 thereof, show an electronic mobile device, such as a mobile phone, a PDA or the like, incorporating the embodiment of the disk drive unit according to the invention. The device/disk drive unit comprises a housing 1 with an upper wall 2, side walls 3, and a lower wall 4.

In this case an opening 5 is provided in the upper wall 2 for inserting a disk A into the housing in order to use it in the disk drive unit.

In the embodiment shown, the disk A is preferably an optical disk which is contained in a cartridge B to protect the disk against dust, scratches, or the other environmental influences which may affect the operation of the disk A. However, the invention is also suitable for co-operation with a disk, optical or non-optical, without cartridge.

A loading mechanism of the disk drive unit comprises a slide 6, in this case including a tray 7 and a cover 8. The tray 7 is adapted to receive a disk A or the disk cartridge B therein through the opening 5 in the upper housing wall 2. The slide 6 is slidable with respect to the upper wall 2 of the housing 1 between a first position in which the tray 7 is substantially aligned with the opening 5 in the housing wall 2 so as to insert or remove a disk cartridge B and a second position in which the tray 7 and the disk A contained therein are aligned with a disk drive 9 and in particularly a drive shaft 10 thereof. In this second position the cover 8 covers the opening 5 in the housing wall 2.

The tray 7 of the slide 6 comprises a bottom 11 and four upright walls 12. The upright walls 12 are dimensioned such that they seal off the inner side of the housing wall 2 with their upper edges so as to prevent dust from entering the housing 1, or at least limit this to a sufficient extent. The bottom 11 of the tray 7 has an access opening 14 to allow co-operation of the disk drive 9 and the disk A, in particular to allow engagement between a drive shaft 10 and a hole in the disk A and to allow a read/write head (not shown) of the disk drive 9 to co-operate with a data surface area of disk A. For this purpose the cartridge B also has a (closable) access opening or the like. The disk drive unit may be provided with means for opening or closing any closure of the access opening 14 in the bottom 11 of the tray 7 and any access opening in the disk cartridge B. As usual, means may be provided for positioning the cartridge in the disk drive and for detecting a correctly positioned cartridge. Furthermore, the disk drive unit may comprise means for locking the slide 6 in the second position as long as the motor of the disk drive is rotating.

To allow engagement and disengagement of the drive shaft 10 of the disk drive 9 with the hub or hole in the disk A, the disk drive 9 is movable relative to the slide 6, particularly in a direction substantially perpendicular to the direction of movement of the slide 6. The movement of the disk drive 9 may be a translational, pivotal, or combined movement. In the embodiment shown, the disk drive 9 is pivotable about a pivot axis 14 provided on the side of the disk dive 9 closest to the opening 5 in the housing wall 2. In a simple embodiment, the disk drive 9 and/or the tray 7 is provided with at least a guide groove (not shown) extending mainly in a direction substantially parallel to the sliding direction of the slide 6, but slightly offset therefrom. The other one of said tray 7 and disk drive 9 comprises an engagement member which may be a pin or some other projection designed to engage in said guide groove.

If the direction of the guide groove has a slight angle to the direction of movement of the slide 6, when the slide 6 is in its first, loading position (FIG. 1), engagement of the engagement member and the guide groove will cause a pivoting movement of the disk drive 9 about the pivot axis 14 during the sliding movement of the slide 6 into the second, loaded position (FIG. 2). These movements are illustrated by arrows in FIG. 2. Of course, other mechanical coupling means are conceivable, while the disk drive 9 may also be moved electrically in more expensive devices. As an alternative, the slide may perform a combined movement to allow the disk to come into and out of engagement with the drive shaft of the disk drive.

FIG. 4 shows that the cover 8 is provided with guide flanges 15 at its sides extending parallel to the direction of movement of the slide 6. The guide flanges 15 may comprise a lower ridge 16 for engagement in a guide groove 17 in the side walls 3 of the housing 1. In this manner, the cover 8 of the slide 6 is properly guided in a simple manner in order to allow and guide a manually driven sliding movement of the slide 6. Additionally or alternatively, the tray 7 may also include guide means to co-operate with the upper wall 2 or side walls 3 of the housing 1. The flanges 15 are also used to grip the slide 6 in order to move it by hand.

The upper surface 18 of the cover 8 may be used to accommodate operating means of the device, such as keys, a display, or other means. If these operating means require an electrical or electronic connection with the housing 1, an electrical or electronic connection may be provided between the slide 6 and the housing 1, for example through a flex wire, a wireless link, or the like. Furthermore, the cover 8 may be constructed such that, in the first position of the slide 6, it is slid over operating means of the device, such as keys, a display, or other operating means. In this way efficient use is made of the surface area of the upper housing wall 2 and the cover 8.

It will be clear from the foregoing that the invention provides a disk drive unit and device having a simple, reliable, robust, and compact loading mechanism, which is sealed effectively.

The invention is not restricted to the above-described embodiment as shown in the drawing, which can be varied in several ways without departing from the scope of the invention. The disk may be readable/writable by other means, such as magnetically. The slide may be guided in another way, and may also be arranged substantially within the housing. Thus, the disk drive unit may also be adapted to co-operate with a disk without a cartridge.

1. A disk drive unit having a disk loading mechanism, comprising:
a housing having an opening in a wall thereof for inserting or removing a disk into or from the housing,
a disk drive accommodated in the housing and adapted to engage and rotate a disk in order to allow a head to read data from or write data on a disk,
a loading mechanism for receiving a disk through the opening in the housing and bringing it into engagement with the disk drive, and vive versa, said loading mechanism comprising:
a slide which is slidable with respect to the housing and the disk drive between a first position for receiving a disk and a second position covering the opening and allowing the disk drive to engage the disk,
wherein the slide is slidable substantially alongside the wall of the housing in which the opening is made and is adapted to receive the disk through the opening in the housing.

2. The disk drive unit of claim 1, wherein the slide comprises a tray to receive the disk in it, said tray having a bottom and a circumferential wall sealing against the adjacent wall of the housing.

3. The disk drive unit of claim 2, wherein the bottom of the tray is provided with a (closable) opening to gain access to the disk.

4. The disk drive unit of claim 2, wherein the tray of the slide is slidably guided within the housing, along the inner side of said housing wall having the opening.

5. The disk drive unit of claim 1, wherein the slide and the disk drive are operatively coupled to obtain a relative movement during the sliding movement of the slide so as to bring a shaft of the disk drive into and out of engagement with the disk.

6. The disk drive unit of claim 5, wherein the slide and the disk drive are mechanically coupled through an operating mechanism.

7. The disk drive unit of claim 6, wherein the operating mechanism comprises at least a groove on one of said slide and disk drive, extending mainly in a direction substantially parallel to the sliding direction of the slide, and furthermore an engagement member on the other one of said slide and disk drive and adapted to come into engagement with the groove to effect said relative movement.

8. The disk drive unit of claim 6, wherein the disk drive is pivotable about an axis on a side of the disk drive closest to the opening and extending substantially perpendicularly to the direction of movement of the slide and substantially parallel to the disk drive.

9. The disk drive unit of claim 8, wherein the slide is manually slidable.

10. The disk drive unit of claim 9, wherein the slide is guided on guides on the outside of the housing, which guides are preferably arranged on walls of the housing adjacent the wall having the opening and extend parallel to the direction of movement of the slide.

11. The disk drive unit of claim 1, wherein the slide comprises a cover dimensioned so as to cover the opening in the housing wall when the slide is in the second position, which cover slides along the wall of the housing containing the opening, preferably on the outside thereof.

12. The disk drive unit of claim 4, wherein the cover and tray are positioned substantially adjacent to each other.

13. The disk drive unit of claim 11, wherein the cover is provided with operating means of the disk drive unit, such as a display, keys, and the like, and wherein there is an electrical connection between the cover and the housing.

14. The disk drive unit of claim 11, d, wherein the cover is adapted to cover operating means of the disk drive unit, such as a display, keys, or the like, when in its second position.

15. The disk drive unit of claim 1, integrated in a portable, handheld device, such as a mobile telephone.

16. The disk drive unit according to claim 1, intended to be used with a disk contained in an openable cartridge, the unit comprising means for positioning and/or opening the cartridge.
